(19) United States
(12) Patent Application Publication
(10) Pub. No.: US 2009/0299816 A1
(43) Pub. Date: Dec. 3, 2009

(54) Search Tool Advertising

(75) Inventors: Daniel J. Zigmond, Menlo Park, CA (US); Jonathan J. Rosenberg, Los Gatos, CA (US); Hal R. Varian, Danville, CA (US)

Correspondence Address: FISH & RICHARDSON P.C., PO BOX 1022, MINNEAPOLIS, MN, 55440-1022, US

(73) Assignee: Google Inc., Mountain View, CA (US)

(21) Appl. No.: 12/132,288

(22) Filed: Jun. 3, 2008

(51) Int. Cl. G06Q 30/00

(52) U.S. Cl. 705/10; 705/14.49

(57) ABSTRACT

A content item is presented to at least one user via a first medium, where the content item identifies a target concept. The first medium can be, for instance, radio, television, print advertisements, or the Internet. The number of requests at a search tool for the target concept are measured subsequent to the presentation of the content item in the first medium. The difference (e.g, increase or decrease) in use of a second medium, e.g., the Internet, subsequent to the presentation of the content item in the first medium can be measured, which can be used to modify a value associated with a subsequent presentation of the content item using the first medium.

### BACKGROUND

This disclosure relates to information retrieval.

Interactive media (e.g., the Internet) has great potential for improving the targeting of content items, e.g., advertisements, to receptive audiences. One form of online advertising is ad syndication, which allows advertisers to extend their marketing reach by distributing ads to additional partners. For example, third party online publishers can place an advertiser's text or image ads on the publishers' web pages to drive online customers to the advertiser's web page. As another example, ads may be placed on run on television channels to drive viewers to use or purchase online products or services.

### SUMMARY

According to an implementation, there is disclosed a computer-implemented method. The method includes presenting a content item to at least one user using a first medium, the content item identifying a target concept, measuring a difference in use (e.g., a decrease or increase in use) of a second medium subsequent to the presentation of the content item, and modifying a value associated with a subsequent presentation of the content using the first medium based on the measured difference in use of the second medium.

According to one feature, wherein measuring the difference in use of a second medium includes measuring the use of the target concept in the second medium. Measuring the use of the target concept in the second medium can also include measuring the use of the target concept as search term in a search tool associated with the second medium.

According to another feature, the method also includes presenting a second content item including the target concept in the second medium. The method can also include receiving, in the second medium, at least one user selection identifying the content item. According to yet another feature, the method can include identifying a search of the target concept, and identifying one or more search results associated with the target concept. Additionally, measuring the difference in use of a second medium can include measuring a number of the at least one user selections identifying the content item. The revenue generated from the received user-selection of the content item can also be measured.

According to another feature, presenting the content item to at least one user can also include determining whether the content item is contextually relevant to a content of a web page, and presenting the content item on the web page based on the determination. Presenting the content item to at least one user can also include presenting an advertisement to the at least one user. According to still another feature, the method can include determining the location of the content item on a web page prior to presenting the content item to the at least one user.

The content item can be an advertisement, and the advertisement can include the target concept and/or identify the name of a search tool. Additionally, the target concept can include a search query or can be associated with one or more search queries. According to another feature, modifying a value associated with a subsequent presentation of the content can include modifying a cost of presenting the content item or modifying a placement position of the content item in the first medium, or modifying a time or duration of presenting the content item using the first medium.

According to another implementation, the method can include presenting an advertisement to at least one user on a web page, the advertisement identifying an Internet search tool and a target concept, and measuring a number of requests at the search tool for the target concept subsequent to presenting the advertisement to the at least one user.

According to a feature, the method can also include identifying a time the advertisement was presented to the at least one user. Additionally, measuring the number of requests at the search tool for the target concept can include measuring the number of requests at the search total for the target concept for a period of time beginning at the time the advertisement was presented to the at least one user, or for a period of time following the time the advertisement was presented to the at least one user.

According to yet another feature, the method can include identifying a presentation position of the advertisement relative to one or more other advertisements, which can be the order of presentation of the advertisement relative to the one or more other advertisements. The method can also associate the measured number of requests with the identified presentation position. The method can also present the advertisement for at least one subsequent time at a different presentation position relative to one or more other advertisements. According to another feature, the method can include measuring the number of requests at the search tool for the target concept subsequent to presenting the advertisement for the at least one subsequent time at the different presentation position. The measured number of requests for the advertisement at the presentation position can also be compared to the measured number of requests for the advertisement at the different presentation position.

According to another implementation, a system is disclosed. The system includes a means for presenting a content item to at least one user on a web page, the content item identifying an Internet search tool and a target concept, and a means for receiving a user-selection of the content item. The system also includes a means for automatically executing a search of the target concept using the Internet search tool upon receiving the user selection of the content item, and a means for identifying one or more search results associated with the target concept.

According to yet another implementation, a system is disclosed that includes a means for presenting a television or radio advertisement to at least one user, the advertisement identifying a search tool and a target concept, a means for measuring a number of requests at the search tool for the target concept subsequent to presenting the advertisement to the at least one user, and a means for. modifying a value associated with a subsequent presentation of the content using the first medium.

### BRIEF DESCRIPTION OF THE DRAWINGS

FIG. 1 is a block diagram of an example advertising system.

FIG. 2 is a flow diagram of an example process for providing advertisements.

FIG. 3 is a flow diagram of an example process for processing a content item in an interactive environment.

FIG. 4 is a block diagram of an example advertising system.

FIG. 5 is flow diagram of an example process for measuring effectiveness of television, radio, and/or print advertisements.

FIG. 6 is a schematic diagram of an example computer system that can be utilized to implement the systems and methods described herein.

### DETAILED DESCRIPTION

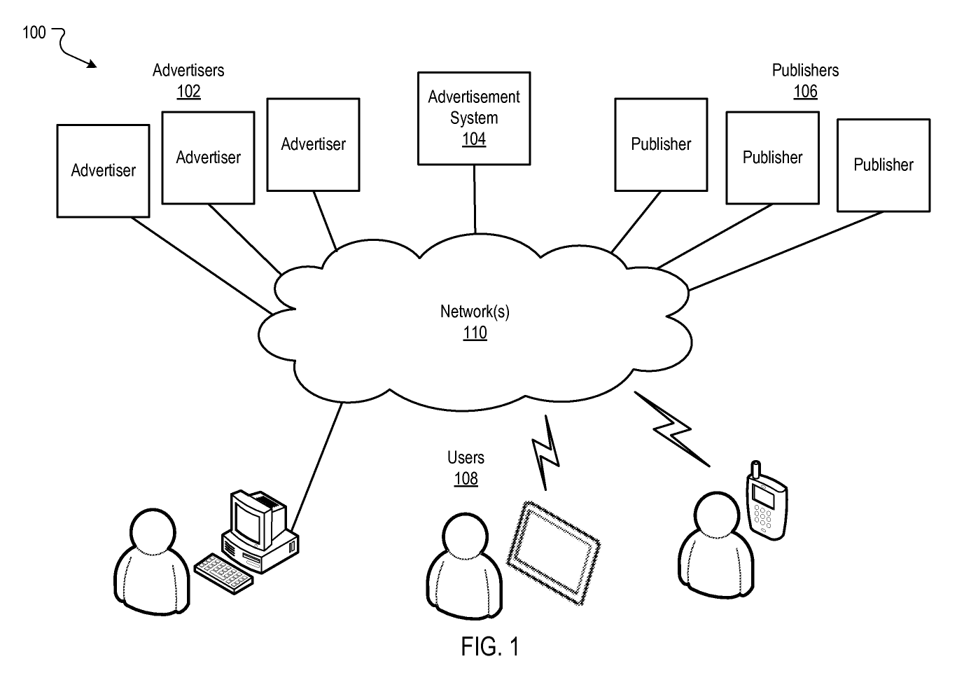

FIG. 1 is a block diagram of an example content delivery (e.g., advertising) system 100. According to an implementation, the system 100 provides content items, in response to, for example, a query. In some implementations, the system 100 provides content items to users via television, radio, or print media in response to paid placement of the content items. The content items can be in the form of advertising or advertisements (“ads”). Other forms of content including other forms of sponsored content are possible. One or more networks 110, such as a local area network (LAN), wide area network (WAN), the Internet, television or radio distribution systems (e.g., a satellite delivery system, hybrid fiber-coax system, etc.) or a combination thereof, connects the advertisers 102, an advertisement system 104, publishers 106, and/or users 108.

In some implementations, one or more advertisers 102 can directly, or indirectly, enter, maintain, and track advertisement (“ad”) information in an advertisement system 104. The advertisements may be in the form of graphical advertisements, such as banner advertisements, text only advertisements, image advertisements, audio advertisements, video advertisements, advertisements combining one of more of any of such components, etc. Advertisements for placement in a user-interactive environment, such as for placement on a web page, may also include embedded information, such as links, meta-information, and/or machine executable instructions. In some implementations, the advertisements can include meta-information that includes a target concept, such as a search query. For instance, an advertisement may instruct a user to execute a search for “auto insurance” on the search tool Google®.

One or more publishers 106 may submit requests for advertisements to the system 104. Alternatively, the request may come directly from the users 108 upon executing publisher 106 embedded code as instructed by the advertisement system 104. The system 104 can respond by sending advertisements (e.g., when an associated publication is rendered) to either the requesting publisher 106 or directly to the user 108 (e.g., for placement on one or more of the publisher's properties (e.g., web pages and other network-distributed content)).

In some implementations, the advertisements may be transmitted to the user(s) 108 via a television or radio distribution system such that the user can view or listen to the advertisements via conventional advertising mediums, such as a television, radio, newspaper, printed publication or the like. As discussed above, while reference is made to advertisements, other content items can be provided by the system 104.

Other entities, such as users 108 and the advertisers 102, as well as the publishers 106 can provide usage information to the system 104, such as, for example, whether one or more users in a user-interactive medium, for instance, the Internet, are entering queries related to the subject matter (e.g., target concept) presented in an advertisement. The usage information can also include a measurement of a number of requests at an Internet search tool for the target concept identified by an advertisement after the advertisement is presented to the user 108, such as in a television or radio advertisement, or in a print advertisement. Third party information providers (not illustrated) can also provide usage information, including, for instance, estimates on the number of users that viewed or listened to a television or radio advertisement. In some implementations, usage information can identify whether a click-through related to an interactive (e.g., web page) advertisement has occurred, whether a conversion has occurred, or whether some other defined event has occurred. Such usage information can be processed to measure performance metrics, such as click-through rates, conversion rates, etc.

According to some implementations, a value associated with a subsequent presentation of the content and/or target concept can be modified. For instance, based on the usage information the price, time, and/or duration of a subsequent presentation can be altered. According to another implementations, the advertising medium for subsequent can also be changed based on the usage information.

In a user-interactive environment such as the Internet, a click-through can occur, for example, when a user of a device selects or “clicks” on an advertisement. The click-through rate can be a performance metric that is obtained by dividing the number of users that clicked on the advertisement or a link associated with the advertisement by the number of times the advertisement was delivered. A “conversion” occurs when a user, for example, consummates a transaction related to a previously served advertisement. What constitutes a conversion may vary from case to case and can be determined in a variety of ways. For example, a conversion may occur when a user clicks on an advertisement, is referred to the advertiser's web page and consummates a purchase there before leaving that web page. Alternatively, a conversion may be defined as a user being shown an advertisement, and making a purchase on the advertiser's Web page within a predetermined time (e.g., seven days). A conversion rate can be defined as the ratio of the number of conversions to the number of impressions of the advertisement (i.e., the number of times an advertisement is rendered) or the ratio of the number of conversions to the number of selections (or the number of some other earlier event).

Other usage information and/or performance metrics can also be used. The usage information and/or performance metrics can, for example, be revenue related or non-revenue related. In another implementation, the performance metrics can be parsed according to time, e.g., the performance of a particular content item may be determined to be very high on weekends, moderate on weekday evenings, but very low on weekday mornings and afternoons, for example. This usage information can include measured or observed user behavior related to advertisements that have been served. The system 104 performs financial transactions, such as crediting the publishers 106 and charging the advertisers 102 based on the usage information.

According to some implementations, performance metrics can be identified as corresponding to the time an advertisement is presented to a user via a first medium such as television, radio, or print advertisement. For instance, the number of requests at a second medium, such as an Internet search tool, for a particular target concept identified by an advertisement may be measured for a period of time following the presentation of the concept to users via the first medium, such as via television, radio, or print advertisement.

Performance metrics can also associate metrics with the presentation position of a television or radio ad within a group of ads. For instance, metrics identifying a number of requests at a search tool for a particular target concept may identify the number of requests when the advertisement runs as the first commercial in a two-minute commercial segment, the number of requests when the advertisement runs as the second commercial in a segment, and the like, such that differences in the effectiveness of an advertisement based on its presentation position can be determined.

Additionally, to indirectly make both the first and second mediums more profitable, other content having the same or different target concepts may be displayed in the first and second mediums. For instance, an advertisement can be presented to users via the radio and a particular radio station in order to encourage those users to utilize an Internet search tool to perform one or more specific searches. Advertisements for the radio station and/or target concept may be presented to users that execute searches corresponding to or identifying the target concept.

One example of a publisher 106 is a general content server that receives requests for content (e.g., articles, discussion threads, music, video, graphics, search results, web page listings, information feeds, etc.), and retrieves the requested content in response to the request. The content server may submit a request for advertisements to an advertisement server in the system 104, or embed code in the rendered page for the user 108 to execute and retrieve said ads. The advertisement request may include a number of advertisements desired. The advertisement request may also include content request information. This information can include the content itself (e.g., page or other content document), a pointer to the content by way of a uniform resource locator (“URL”), a category corresponding to the content or the content request (e.g., arts, business, computers, arts-movies, arts-music, etc.), part or all of the content request, content age, content type (e.g., text, graphics, video, audio, mixed media, etc.), geo-location information, etc.

In some implementations, the content server (or a viewer (e.g., browser) associated with a content requester) can combine the requested content with one or more of the advertisements provided by the system 104. This combined content and advertisements can be sent/presented to the user 108 that requested the content. The content server can transmit information about the advertisements back to the advertisement server, including information describing how, when, and/or where the advertisements are to be rendered (e.g., in HTML or JavaScript™).

As can be appreciated from the foregoing, the advertising system 104 can serve publishers 106 such as content servers. The system 104 permits serving of advertisements targeted to content (e.g., documents) served by content servers. For example, one or more content servers may include one or more documents. Documents may include web pages, email, content, embedded information (e.g., embedded media), meta-information and machine executable instructions, and advertisement spots available. The advertisements inserted into advertisement spots in a document can vary each time the document is served or, alternatively, can have a static association with a given document.

In one implementation, the publisher 106 can combine content with the one or more advertisements provided by the system 104 on a web page associated with the publisher 106 based on psychographic, demographic, as well as contextual relevance of the content and the advertisement.

Another example of a publisher 106 in the system 100 is a television, print, or radio publisher that is capable of serving advertisements requested by the advertisement system 104 and/or advertisers 102. Although this process is illustrated in FIG. 1 and described as automated in an user-interactive environment such as the Internet, the process of placing a video or audio (e.g., radio) advertisements in television or radio media, such as a broadcast, may be done at least in part manually, as is well known. For instance, an advertiser 102 may request the placement of an advertisement that includes the identity of a search tool and a target concept in television, radio, or print (e.g., newspaper) media. The advertisement can be distributed manually (e.g., as is possible in the case of print media) and/or via one or more networks for distribution to one or more users 108. According to some implementations, advertisements can be distributed to users via web pages, as described above, simultaneously with the running of an advertisement in television, radio, or print media.

Based on the usage information and/or performance metrics of an advertisement, a value associated with a subsequent presentation of the content and/or target concept can be modified. For example, the price, time, and/or duration of a subsequent presentation for a radio or television ad can be altered based on the performance metrics collected, for instance, at an Internet search tool immediately after the original presentation of the target concept in a television, radio, or print advertisement. According to another implementations, the advertising medium for subsequent can also be changed based on the usage information.

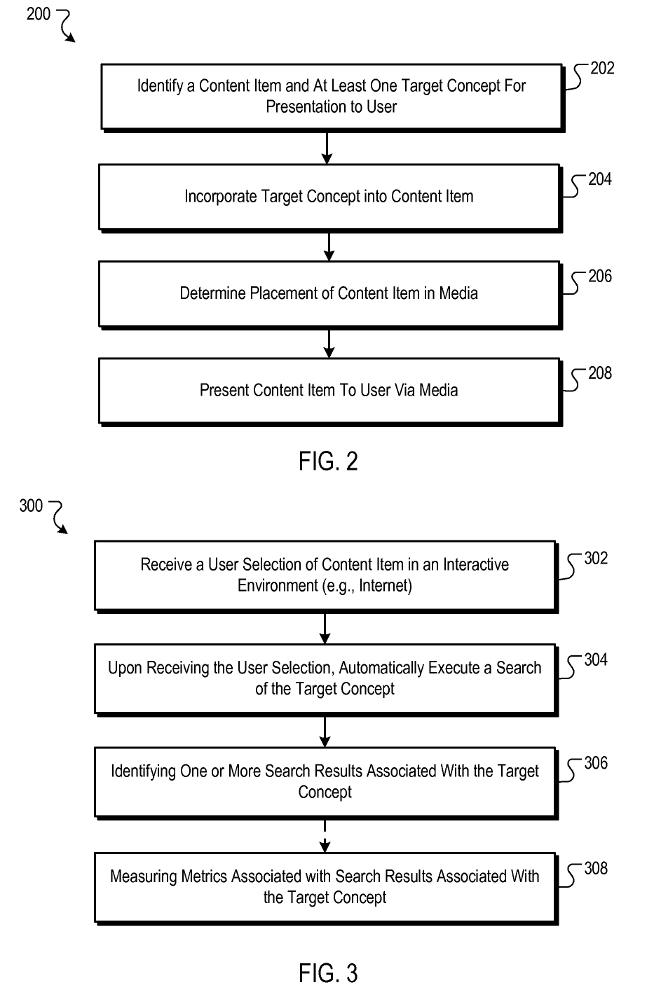

FIG. 2 is a flow diagram of an example process 200 for providing advertisements. The process 200 can, for instance, be implemented in a system such as the system 100 of FIG. 1. A content item is identified, along with at least one target concept, for presentation to a user 202. The content item and/or target concept can be identified by an advertiser manually or automatically via a content engine. The target concept is incorporated into the content item 204, for instance, by the advertiser or the advertisement system 204. According to some implementations, the content item can be an advertisement for a search tool, and the target concept can be a target search term or terms (i.e., search query) the advertisement seeks to have a user execute. For example, in an interactive user environment, the content item can represent a banner ad that states “Looking for car insurance? Do a search for ‘car insurance’ at Google.com”, where the target concept is ‘car insurance’. The same or a similar advertisement may be placed as a television, radio, or print advertisement.

The placement of the content item in a media is determined 206, and the content item is presented to one or more users via the media 208. The placement of the content item in a media can be executed by the advertisement system, publishers, and/or advertisers, and can include a determination as to the type of media (e.g., Internet web page(s), television, radio, print, etc.) as well as a determination as to time, form, and placement specifics. For instance, a content item that is an Internet banner advertisement may be placed on one or more web pages based, for instance, on the content of the web pages, and may be placed in several locations on web pages, as is known in the art. As another example, a content item that is a television advertisement may be placed on particular television channels, during specific time slots, and may be placed in one or more presentation positions within a series of commercials.

FIG. 3 is a flow diagram of an example process 300 for processing a content item in an interactive environment. The process 300 can, for instance, be implemented in a system such as the system 100 of FIG. 1. A user-selection of a content item is received 302. For instance, a content item may be selected by a user via a point and click selection of the content item, which may be a banner advertisement on a web page. As an example, the content item may be a banner ad that states “Looking for car insurance? Do a search for ‘car insurance’ at Google.com.” The receipt of the user selection may be executed, for instance, by a computer serving a web page to the user, as is known.

Upon receipt of the user selection, a search is automatically executed for the target concept 304. Continuing with the above illustrative ‘car insurance’ example, a search may be executed for ‘car insurance’ using a particular search tool. According to an implementation, the search tool used to execute the search may represent the advertiser, which may wish to drive use of the search tool. In some implementations, upon a user selection of the content item the search is automatically executed by a search tool. One or more search results associated with the target concept are identified 306, and may be presented to the user.

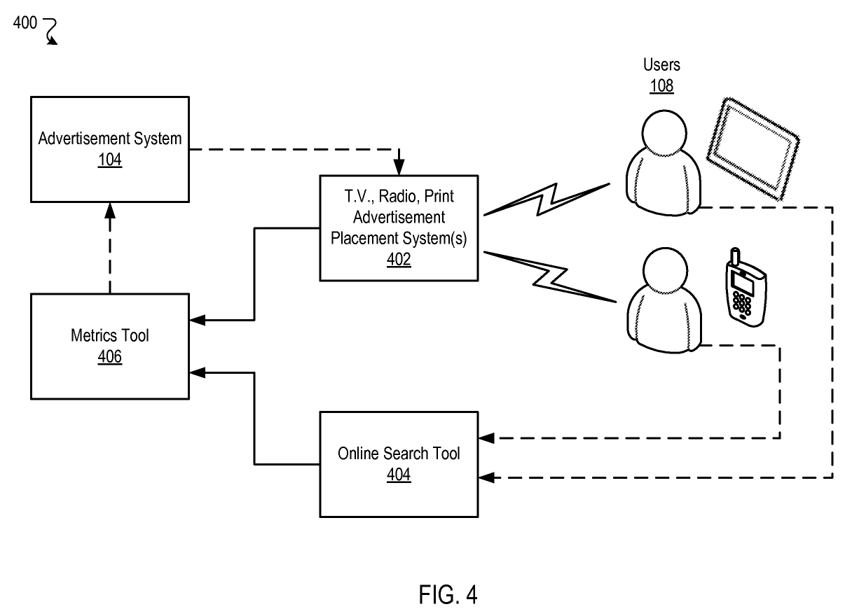

Optionally, metrics associated with the search results, presentation and/or placement of the content item may be measured to gauge effectiveness of the content item. As an example, the number of user selections of the content item for each display of the content item may be measured. As another example, revenue resulting from the content item may be collected. This information may be useful to an advertiser in determining the effectiveness of the content item. Optionally, this information may be tied to a subsequent display of content items 310, where a value associated with the display may be modified, such as the cost of their placement, their placement position, the time of day, their duration, their creative presentation, and the like. FIG. 4 is a block diagram of an example advertising system 400 for placement of television, radio, and print advertisements. The system 400 includes one or more television, radio, and/or print advertisement placement systems 402. According to an implementation, these systems 402 can include the one or more networks 110 described with respect to FIG. 1, and serve to place an advertisement in the advertiser-selected media for presentation to one or more users 108, where the advertisement identifies at least one target concept. The one or more television, radio, and/or print advertisement placement systems 402 can also track presentation information, including when and where the advertisements are placed in the television, radio and/or print media. For instance, the channels and time of a television advertisement are tracked and stored by the one or more television, radio, and/or print advertisement placement systems 402.

The advertising system 400 also includes an online search tool 404. According to some implementations, this may represent a search system with a front-end web page interface, such as Google.com. The block diagram of the system 400 illustrates that the users 108 that receive a presentation of an advertisement via television, radio, and/or print advertisement placement system 402 may then communicate with the online search tool 404. For instance, if a television advertisement instructs users 108 to execute a search for the target concept ‘car insurance’ at the search tool ‘Google.com’, the users 108 that are subjected to the advertisement may proceed to use the online search tool ‘Google.com.’

The advertising system 400 further includes a metrics tool 406. The metrics tool 406 is in communication with the one or more television, radio, and/or print advertisement placement systems 402 and the online search tool 404. According to an implementation, the metrics tool 406 receives the presentation information identifying when and where the advertisements are placed in the television, radio and/or print media. The metrics tool 406 also receives metrics from the online search tool 404, including the number of requests at the search tool for the target concept, the times of those search requests, and other information such as online revenue generated for the target concept searches. The metrics tool 406 can provide reports to the advertisement system 104 to identify whether the presentation of advertisements are associated with increased traffic at the online search tool 404, which suggests that the advertisements are effective.

Using the presentation information and the metrics for the online search tool, the metrics tool 406 can identify the effectiveness of advertisements having different presentation information. For instance, an advertisement that is placed before any other advertisements during a commercial break may result in greater use of the online search tool 404 than the same advertisement placed second to another advertisement in the same time slot. According to an implementation, one or more metrics reports can be provided to the advertisement system 104 and/or to advertisers, which can use the information to alter the placement of advertisements, including when or where advertisements are placed, and/or their form or content.

According to yet another implementation, the metrics tool 406 may receive data from third parties that identifies metrics associated with the audience of a placed advertisement. For instance, the metrics tool 406 may receive an estimate of the number of users that view a particular advertisement presented by the one or more television, radio, and/or print advertisement placement systems 402. The metrics tool 406 can associate this information with metrics from the online search tool and the presentation information to determine the percentage of viewing (i.e., in television or print systems) or listening (i.e., in radio systems) users that use the online search tool 404 subsequent to the presentation of an advertisement for the online search tool 404. If the percentage of viewing/listening users that use the online search tool 404 subsequent to placement of an advertisement is consistent over time, the metrics tool 406 can estimate the television or radio audience based on the traffic at the online search tool 404.

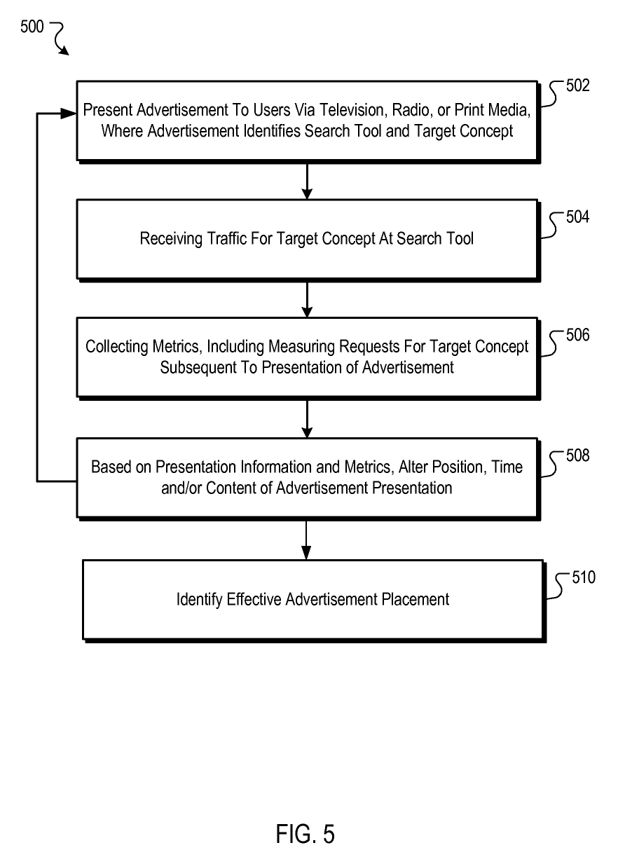

FIG. 5 is flow diagram of an example process 500 for measuring effectiveness of television, radio, and/or print advertisements. An advertisement is presented to users via a first medium, such as television, radio, and/or print media, where the advertisement identifies a search tool and target concept 502. Traffic is received at a second medium, such as the Internet. For instance, traffic can be received at a search tool for the target concept 504, and metrics are collected, including the number of requests for the target concept subsequent to the presentation of the advertisement are measured 506. The measurement of requests can be executed, for instance, by the online search tool 404. Other metrics can include, for instance, the time of the requests for the target concept. Using presentation information (e.g., the location, time, form, etc. of the presented advertisement) and the metrics, the position, time, or form of an advertisement may be altered 508. Iterative presentation of advertisements permits the identification of effective advertisement placement, which can include the time, location, and form of advertisements 510.

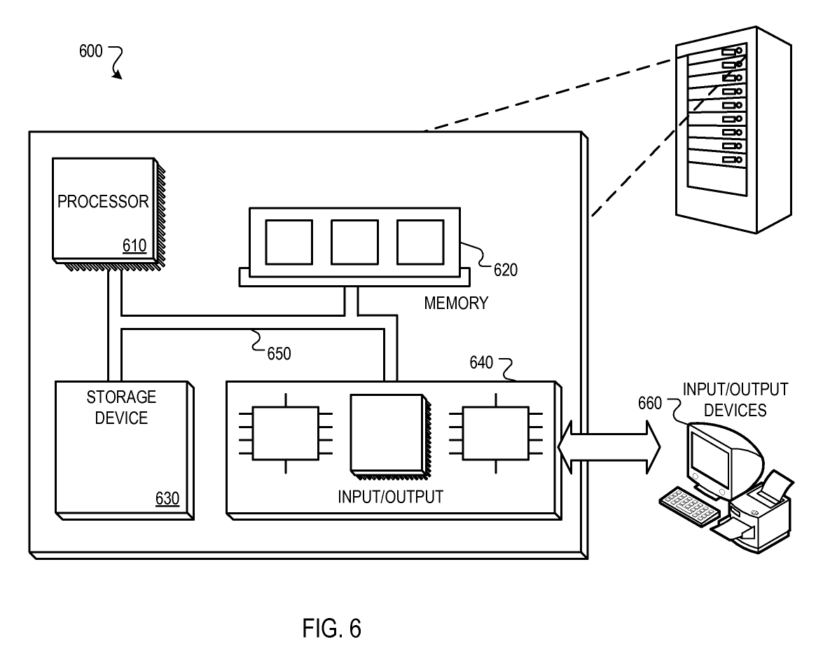

FIG. 6 is a schematic diagram of an example computer system 600 that can be utilized to implement the systems and methods described herein. The system 600 includes a processor 610, a memory 620, a storage device 630, and an input/output device 640. Each of the components 610, 620, 630, and 640 can, for example, be interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 can, for example, include a hard disk device, an optical disk device, or some other large capacity storage device.

The input/output device 640 provides input/output operations for the system 600. In one implementation, the input/output device 640 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 660. Other implementations, however, can also be used, such as mobile computing devices, mobile communication devices, set-top box television client devices, etc.

The apparatus, methods, flow diagrams, and structure block diagrams described in this patent document may be implemented in computer processing systems including program code comprising program instructions that are executable by the computer processing system. Other implementations may also be used. Additionally, the flow diagrams and structure block diagrams described in this patent document, which describe particular methods and/or corresponding acts in support of steps and corresponding functions in support of disclosed structural means, may also be utilized to implement corresponding software structures and algorithms, and equivalents thereof.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

That which is claimed:

1. A computer-implemented method, comprising:
presenting a content item to at least one user using a first medium, the content item identifying a target concept;
measuring a difference in use of a second medium subsequent to the presentation of the content item; and
modifying a value associated with a subsequent presentation of the content item using the first medium based on the measured difference in use of the second medium.

2. The method of claim 1, wherein measuring the difference in use of a second medium comprises measuring the use of the target concept in the second medium.

3. The method of claim 2, wherein measuring the use of the target concept in the second medium comprises measuring the use of the target concept as search term in a search tool associated with the second medium.

4. The method of claim 1, further comprising presenting a second content item including the target concept in the second medium.

5. The method of claim 1, further comprising receiving, in the second medium, at least one user selection identifying the content item.

6. The method of claim 5, where measuring use further includes:
identifying a search of the target concept.

7. The method of claim 5, wherein measuring the difference in use of a second medium comprises measuring a number of the at least one user selections identifying the content item.

8. The method of claim 5, further comprising measuring revenue generated from the received user-selection of the content item.

9. The method of claim 1, wherein presenting the content item to at least one user further comprises:
determining whether the content item is contextually relevant to a content of a web page; and
presenting the content item on the web page based on the determination.

10. The method of claim 1, wherein presenting the content item to at least one user comprises presenting an advertisement to the at least one user.

11. The method of claim 1, further comprising determining the location of the content item on a web page prior to presenting the content item to the at least one user.

12. The method of claim 11, wherein the content item is an advertisement.

13. The method of claim 12, wherein the advertisement includes the target concept.

14. The method of claim 13, wherein the advertisement identifies the name of a search tool.

15. The method of claim 13, wherein the target concept comprises a search query.

16. The method of claim 13, wherein the target concept is associated with one or more search queries.

17. The method of claim 1, wherein modifying a value associated with a subsequent presentation of the content comprises modifying a cost of presenting the content item or modifying the placement position of the content item in the first medium.

18. The method of claim 1, wherein modifying a value associated with a subsequent presentation of the content comprises modifying a time or duration of presenting the content item using the first medium.

19. A method, comprising:
presenting an advertisement to at least one user on a web page, the advertisement identifying an Internet search tool and a target concept; and
measuring a number of requests at the Internet search tool for the target concept subsequent to presenting the advertisement to the at least one user.

20. The method of claim 19, further comprising identifying a time the advertisement was presented to the at least one user.

21. The method of claim 19, wherein measuring the number of requests at the Internet search tool for the target concept subsequent to presenting the advertisement to the at least one user comprises:
measuring the number of requests at the Internet search total for the target concept for a period of time beginning at the time the advertisement was presented to the at least one user.

22. The method of claim 19, wherein measuring the number of requests at the Internet search tool for the target concept subsequent to presenting the advertisement to the at least one user comprises:
measuring the number of requests at the Internet search total for the target concept for a period of time following the time the advertisement was presented to the at least one user.

23. The method of claim 19, further comprising identifying a presentation position of the advertisement relative to one or more other advertisements.

24. The method of claim 23, wherein the presentation position of the advertisement relative to the one or more other advertisements comprises the order of presentation of the advertisement relative to the one or more other advertisements.

25. The method of claim 23, further comprising associating the measured number of requests with the identified presentation position.

26. The method of claim 23, further comprising presenting the advertisement for at least one subsequent time at a different presentation position relative to one or more other advertisements.

27. The method of claim 26, further comprising measuring the number of requests at the Internet search tool for the target concept subsequent to presenting the advertisement for the at least one subsequent time at the different presentation position.

28. The method of claim 27, further comprising comparing the measured number of requests for the advertisement at the presentation position to the measured number of requests for the advertisement at the different presentation position.

29. A system, comprising:
means for presenting a content item to at least one user, the content item identifying an Internet search tool and a target concept;
means for receiving a user-selection of the content item; and
means for automatically executing a search of the target concept using the Internet search tool upon receiving the user selection of the content item.

30. A system, comprising:
means for presenting a television or radio advertisement to at least one user, the advertisement identifying a search tool and a target concept;
means for measuring a number of requests at the search tool for the target concept subsequent to presenting the advertisement to the at least one user; and
means for modifying a value associated with a subsequent presentation of the content using the first medium.
